(19) United States
(12) Patent Application Publication
(10) Pub. No.: US 2026/0159783 A1
(43) Pub. Date: Jun. 11, 2026

(54) SOAP MAKING MOLDS AND COLD PROCESSES OF MAKING SOAP

(71) Applicant: DR. SQUATCH, LLC, Marina Del Rey, CA (US)

(72) Inventors: Cooper Daniel Graves, Marina Del Rey, CA (US); Steven Lam, Westminseter, CA (US); Brian Abraham Fredman, Marina Del Rey, CA (US); Shreyash Sai Kona, Marina Del Rey, CA (US)

(21) Appl. No.: 19/181,515

(22) Filed: Apr. 17, 2025

Related U.S. Application Data
(60) Provisional application No. 63/635,615, filed on Apr. 17, 2024.

(51) Int. Cl. C11D 13/16

(52) U.S. Cl. CPC C11D 13/16

(57) ABSTRACT

In embodiments of the present disclosure, a mold is provided for soap manufacturing in a cold process. The mold includes a plurality of sidewalls, with inner surfaces of the sidewalls facing a cavity of the mold and a bottom connected to the sidewalls. The sidewalls and bottom of the mold are configured such that a surface efficiency ratio (SER) of the mold is greater than about 0.5 in⁻¹. In further embodiments of the present disclosure, a cold process of manufacturing soap is provided. The process includes forming a soap making mixture, pouring the soap making mixture into a slab-type mold, allowing the soap making mixture to harden into soap, and removing the hardened soap from the mold. A viscosity of the soap making mixture relative to a surface efficiency ratio of the mold (V-SER) is greater than about 95,000 CP/in⁻¹.

This application claims the benefit under 35 U.S.C. § 119 of U.S. Provisional Ser. No. 63/635,615, filed Apr. 17, 2024, the disclosure of which is incorporated by reference in its entirety.

### FIELD OF THE DISCLOSURE

The present disclosure relates to soap making molds and cold processes of making soap.

### BACKGROUND

Soaps are made in a wide variety of forms. Often, it is formed as small, solid bars for use as a cleansing agent to remove dirt, oil, and impurities from human skin and other surfaces. Making bars of soap ranges widely in scale and complexity, from small-batch, handcrafted soaps made at home and artistic techniques, to large-scale production to meet market demands.

At its core, soap is produced through a chemical reaction called saponification, which occurs when fats or oils are combined with an alkali, such as lye. Soap compositions are formulated to break down and lift away grease and grime, allowing them to be rinsed off with water, promoting hygiene and cleanliness. Soap compositions can be made from natural ingredients (consistent with a common definition of “soap”) or from synthetic ingredients (“syndet”).

Soap can be made through a hot process or cold process, which differ with respect to heating during the processes. In a hot process, the soap making mixture is heated to accelerate saponification to allow the soap to fully cook before it is poured into a mold. In contrast, a cold process relies on the natural heat generated by the saponification reaction, with no additional heat being applied to the soap making mixture other than to melt oils/fats before the saponification reaction. Cold process soap is often advantageous because it has a smoother finish and can be made with more intricate designs as compared to hot process soap. Forming soap by a cold process also helps to preserve the integrity of the ingredients.

Traditional cold process soap making manufacturing techniques typically rely on the use of larger “block” style molds, which are both wide and deep. Scrap is often produced through the use of such block molds as individual bars of soap are cut from the block shaped product of the molds.

### SUMMARY OF THE DISCLOSURE

In embodiments of the present disclosure, a mold is provided for a cold soap manufacturing process. The mold includes a plurality of sidewalls, with inner surfaces of the sidewalls facing a cavity of the mold and a bottom connected to the sidewalls. The sidewalls and bottom of the mold are configured such that a surface efficiency ratio (SER) of the mold is greater than about 0.5 in⁻¹.

According to further aspects of this embodiment, the SER of the mold is greater than about 0.5 in⁻¹ and less than about 0.99 in⁻¹, or the SER of the mold is greater than about 0.75 in⁻¹ and less than about 0.95 in⁻¹.

In further embodiments of the present disclosure, a mold for a cold soap molding process is provided that includes a plurality of sidewalls, with inner surfaces of the sidewalls facing a cavity of the mold. A bottom surface connected to the sidewalls, and an ejector plate provided above the bottom surface, with the ejector plate having a surface that faces the cavity of the mold, and with the ejector plate being movable relative to the sidewalls and bottom surface. The ejector plate and the mold are configured such that the ejector plate is supported at the corners of the plate and the center of plate such that the ejector plate is maintained perpendicular to the sidewalls as it moves upward.

As further aspects of this embodiment, a plurality of openings are formed in the bottom surface. The sidewalls and ejector plate are configured such that a surface efficiency ratio (SER) of the mold is greater than about 0.5 in⁻¹. More specifically, the SER of the mold is greater than about 0.5 in⁻¹ and less than about 0.99 in⁻¹, and even more specifically, the SER of the mold is greater than about 0.75 in⁻¹ and less than about 0.95 in⁻¹.

In still further embodiments of the present disclosure, a cold process of making soap is provided. The process comprises forming a soap making mixture, pouring the soap making mixture into a slab-type mold, allowing the soap making mixture to harden into soap, and removing the hardened soap from the mold. A viscosity of the soap making mixture relative to a surface efficiency ratio of the mold (V-SER) is greater than about 95,000 CP/in⁻¹.

As further aspects of this embodiment, the V-SER is about 95,000 CP/in⁻¹ to about 300,000 CP/in⁻¹.

In still further aspects, the soap making mixture includes a first soap making mixture that is a first color and a second soap making mixture that is a second color, wherein the first soap making mixture is poured in the mold, the second soap making mixture is poured in the mold, and the first soap making mixture and the second soap making mixture are swirled together in the mold. The V-SER is greater than about 150,000 CP/in⁻¹, or, more specifically, the V-SER is greater than about 150,000 CP/in⁻¹ and less than about 230,000 CP/in⁻¹.

### BRIEF DESCRIPTION OF THE DRAWINGS

FIG. 1 is a view of a mold according to an embodiment of the present disclosure with the ejector plate removed from the mold.

FIG. 2 is a view of the mold shown in FIG. 1 with the ejector plate positioned in the mold.

FIG. 3 is a view of the mold shown in FIG. 1 filled with a soap making mixture.

FIG. 4 is a view of molded soap lifted by the ejector plate out of the mold shown in FIG. 1.

FIG. 5 is a view of the mold shown in the FIG. 1 in combination with an ejection plate lifting device.

FIG. 6 of a plurality of molds according to an embodiment of the present disclosure.

FIG. 7 is a view of a cooling rack and a plurality of molds according to an embodiment of the present disclosure.

FIG. 8 shows the results of tests comparing cooling in cold soap making processes using slab-type molds according to embodiments of the present disclosure and a conventional block-type soap making mold.

It should be noted that to facilitate understanding of the disclosure, in some instances the drawings may not be to actual scale and the dimensions and orientations of some components may be exaggerated.

### DETAILED DESCRIPTION

Aspects of the present disclosure relate to soap making molds and cold processes for making soap at scale. As used herein, the term “soap” means a material that includes fats or oils combined with an alkali, such as in a saponification process. While embodiments of molds are described in the context of making soap, those skilled in the art will recognize that the molds could be used to make many other types of products.

Features of the present disclosure will be expressed as ranges. The ranges may be referred to as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

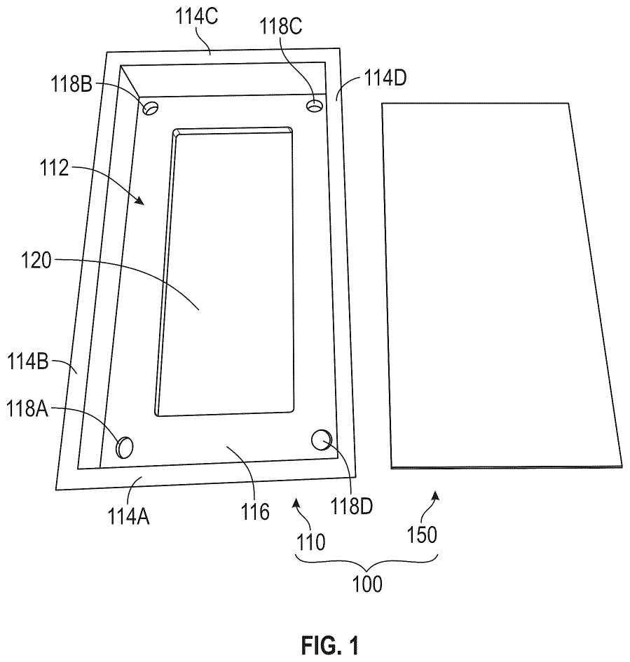

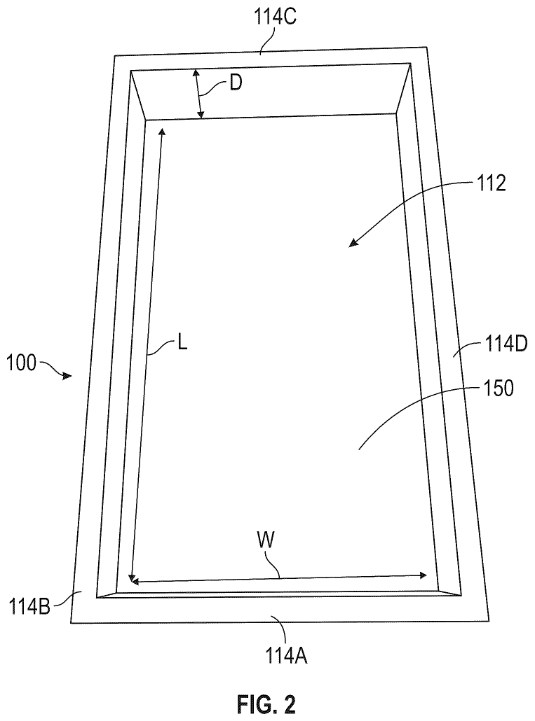

FIGS. 1 and 2 are top views of a soap mold 100 according to an embodiment of the present disclosure. The mold 100 is a slab-type mold, meaning it has a shallow depth relative to its length and width. The mold 100 includes a shell 110 and an ejector plate 150. The ejector plate 150 fits in the cavity 112 of the mold 100 during a soap making process, with a surface of the ejector plate 150 facing the cavity 112. For illustrative purposes, the ejector plate 150 is removed from the shell 110 in FIG. 1, and the ejector plate 150 is positioned in the shell 110 in FIG. 2.

The shell 112 includes four sidewalls 114A-114D extending upward from a bottom surface 116. The inner surfaces of the sidewalls 114A-114D face the cavity 112 of the mold 100. In some embodiments, the sidewalls 114A-114D and bottom surface 116 are individually formed and connected to each other by structures such as butt joints or rabbets. In other embodiments, the sidewalls 114A-114D and the bottom surface 116 are integrally formed as a singular structure.

In the depicted embodiment, four openings 118A-118D are formed at the corners of the bottom surface 116. As will be described below, rods of an ejector plate lifting device extend through the openings 118A-118B to push up the ejector plate 150 to demold soap from the mold 100 in a soapmaking process. An opening 120 is formed at a center of the bottom surface 116. As will also be described below, parts of the ejector plate lifting device extend through the opening 120 to aid in the lifting of the ejector plate 150 during the soap demolding operation. Also, with the large opening 120, the weight of the mold 100 is reduced.

The mold 100 may be made from a variety of materials that are compatible with soap making materials, allow the soap making materials to harden in the mold 100, and allow the soap to be ejected from the mold 100. In some embodiments, the mold 100 may be formed from one or more thermoplastic materials, e.g., by injection molding or thermoforming. Some specific examples of plastics that can be used to construct the mold 100 include polyethylene and polyethylene based plastics such as high-density polyethylene (HDPE), low-density polyethylene (LDPE), ultra-high-molecular-weight polyethylene (UHMW), and medium-density polyethylene (MDPE). Further specific examples of plastics that can be used to construct the mold 100 include polyoxymethylene (e.g., acetal or DELRIN®), polytetrafluoroethylene (PTFE) such as TEFLON®, acrylonitrile butadiene styrene (ABS), nylon, polypropylene (PP), polycarbonate (PC), polyethylene terephthalate (PET), polyvinyl chloride (PVC), epoxy, and polyetherether ketone (PEEK), polyphenylene sulfide (PPS), and polyvinylidene difluoride (PVDF) such as KYNAR®. In other embodiments, the mold 100 can be constructed from other types of materials, such as silicone, metals such as stainless steel, and/or wood. In still further embodiments, the material(s) from which the mold 100 is constructed may be subject to treatment by another material. For example, the material may be coated or otherwise treated with TEFLON®, another plastic, silicone, etc. Those skilled in the art will recognize many other types of materials from which the mold 100 can be constructed and potential treatments to such materials.

As compared to conventional block-type soap making molds, a slab-type soap making mold configuration like mold 100 provides several advantages with respect to the mechanical and structural properties of the mold. For example, a slab-type soap making mold configuration is lighter than an equivalent block-type mold. The lighter weight makes the slab-type mold easier to move in a soap-making process. Further, as compared to a block-type mold, the configuration of a slab-type mold lessens the potential for the soap making material to slosh in or out of the mold during the soap making process. Still more advantages of a slab-type mold configuration for soap making will be described below.

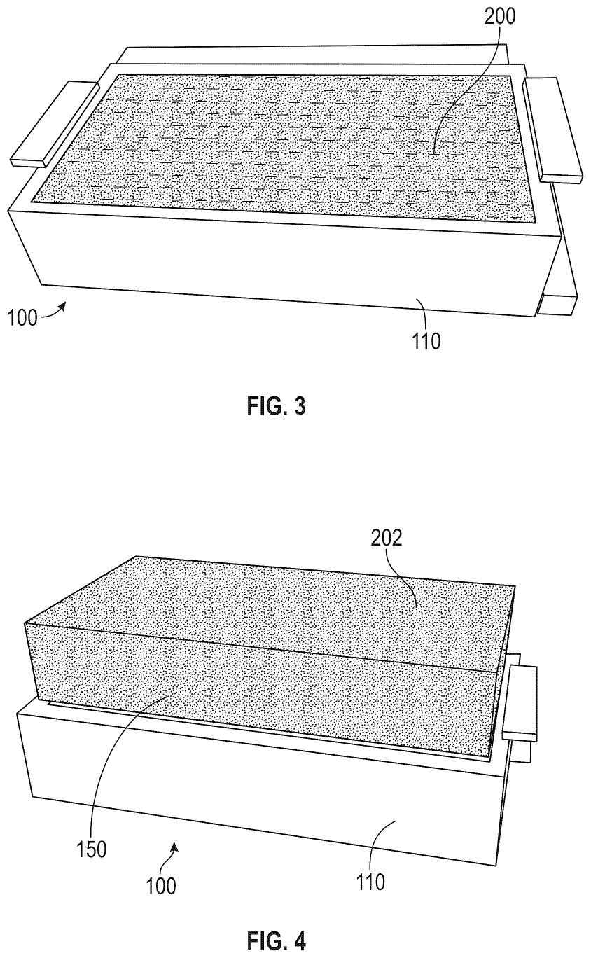

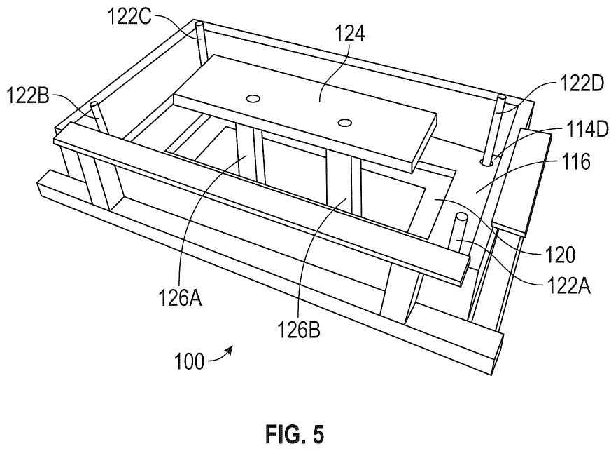

FIG. 3 shows a view of soap making material being molded in a mold according to an embodiment of the present. FIG. 4 shows the soap of FIG. 3 lifted out of the mold by a raised ejector plate. FIG. 5 shows the mold with the soap and ejector plate removed and with the ejector plate lifting device in a raised position.

Referring to FIG. 3, a soap making mixture 200 is poured in the cavity of the mold 100 and the soap making mixture hardens as it cools. The time that it takes for the soap making mixture to harden in the mold may vary. But, as discussed below, a soap making mixture will harden in a slab-type mold such as mold 100 much faster than the same soap making mixture will harden in a conventional block-type soap mold.

The soap 202 may be removed from the mold 100 after the soap making mixture has sufficiently hardened such that the soap 202 can maintain its shape without the support of the mold 100. In the demolding process, the ejector plate 150 moves upward in the mold shell 110. The ejector plate 150 is lifted by an ejector plate lifting device that is positioned below the mold 100. Referring to FIG. 5, the ejector plate lifting device includes rods 122A-122D that extend through the openings 118A-118D in the bottom surface 116 of the mold 100. By providing the rods 122A-122D to the corners of the ejector plate 150, the ejector plate 150 may be evenly supported and lifted. Thus, the ejector plate 150 stays substantially perpendicular to the sidewalls 114A and 114D during the lifting operation. This feature of the present disclosure is advantageous because it prevents the soap 202 from skewing towards one or more of the sidewalls 114A-114D during the lifting operation, which could cause damage to the molded slab of soap.

The ejector plate lifting device also includes a support plate 124 and support plate lifting rods 126A and 126B. The support plate 124 is provided to ejector plate 150 and is raised by the support plate lifting rods 126 through the opening 120 in the bottom surface 112 of the mold shell 110. With the support plate 124, a strong and evenly distributed force may be imparted to the ejector plate 150 during the demolding operation.

Those skilled in the art will also recognize possible variations in the configuration of the ejector plate lifting device. For example, in other embodiments additional lifting rods are used to provide the force for lifting the ejector plate 150.

Those skilled in the art will also recognize numerous types of actuation mechanisms that may be used to provide the force for raising the lifting rods 122A-122D, 126A, and 126B. An example of such an actuation mechanism is a pneumatic structure that uses compressed air to drive pistons to move the rods 122A-122D, 126A, and 126B upward. Similarly, hydraulic systems, which use fluid pressure to create force, can perform the lifting function. Electric actuators are another option, where motors and gears control the movement of the rods 122A-122D, 126A, and 126B to raise or lower the ejector plate 150. As with the various possible actuation mechanisms, the force imparted to the ejector plate 150 by the actuation mechanism may be varied in embodiments of the present disclosure.

The mold 100 may be adopted to prevent the soap from sticking to the inner surfaces of the mold sidewalls 114A-114D and/or the ejector plate 150 during the demolding process. For example, a non-stick paper may be on the ejector plate 150 and/or sidewalls 114A-114D. In other embodiments, a non-stick coating may be applied to the sidewalls 114A-114D and the ejector plate 150.

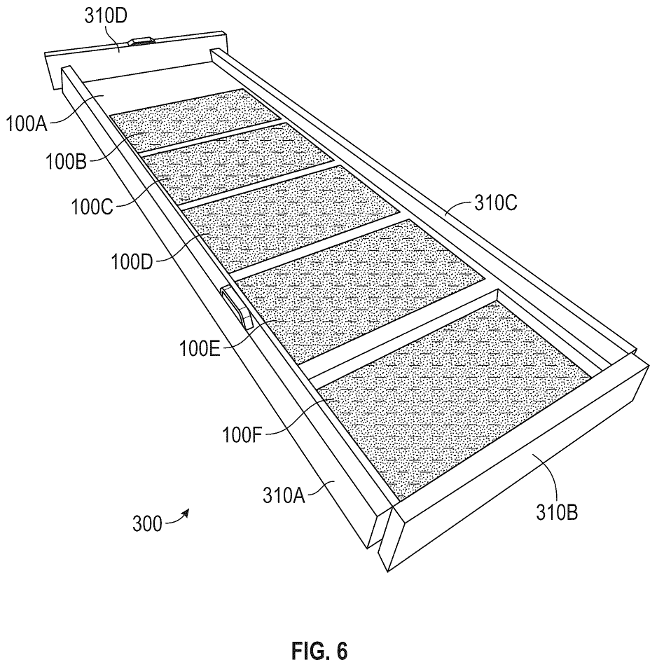

In embodiments of the present disclosure, soap is produced at a manufacturing scale using a plurality of slab-type molds at the same time. FIG. 6 shows an arrangement of slab-type molds 100A-100F in such a manufacturing process. The molds 100A-100F are positioned in a line and secured in place by station walls 310A-310D at a pour station 300 where the soap making mixture is poured into the molds 100A-100F. To facilitate the placement of the molds 100A-100F, one or more of the station walls 310A-310D are hinged to others of the station walls 310A-310D and/or hinged to the base on which the molds 100A-100F and station walls 310A-310D are provided. Thus, at least one of the station walls 310A-310D may move about the hinge to an open position when the molds 100A-100F are provided to or removed from the pour station 300, and the hinged station wall may be moved into closed position to secure the molds 100A-100F during the pouring operation. While six molds 100A-100F are provided in a single line in the embodiment depicted in FIG. 6, there may be different numbers of molds and different arrangements of the molds in other embodiments of the present disclosure. In particular, more than six molds may be used in a soapmaking process. Also, although not depicted in FIG. 6, the pour station 300 may include further structures for the soap molding process, such as devices for pouring the soap making mixture into the molds.

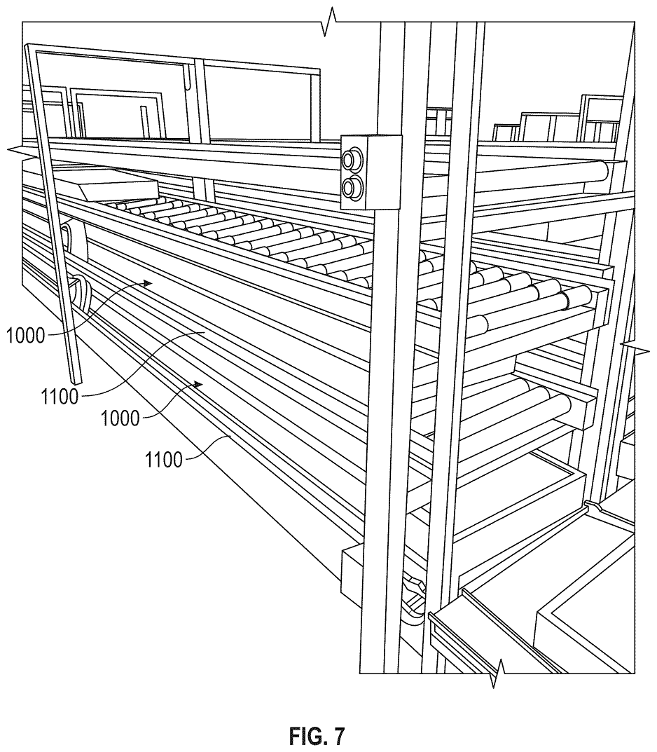

The soap making mixture may be allowed to harden into soap in the molds 100A-100F at the pour station 300. However, in other embodiments of the soap making process at manufacturing scale, the molds 100A-100F may be moved to another location while the soap making mixture hardens. FIG. 7 shows an example of such a location. In this embodiment, a plurality of molds 1000 are provided on cooling racks 1100 that are vertically arranged. The molds can be moved from a pour station to the cooling racks 1100 by any means available, such as by hand, mechanical lift, or conveyor.

After the cooling is completed and the soap is sufficiently hardened, the molds may be moved to a demolding location that includes an ejector plate lifting device as is described above. Then, the slab of soap may be cut into a desired size and further processed, e.g., packaged.

Referring again to FIG. 1, in embodiments of present disclosure the soapmaking mold 100 is configured as a slab mold, meaning that the mold 100 has a shallow depth D as compared to its length L and width W. As such, the slab mold 100 provides a surface efficiency ratio (SER) that is significantly greater than conventional block-type soapmaking molds. The SER is a ratio of the total surface area of the molding material in the mold to the volume of the molding material in the mold. With the configuration of the mold 100, the surface area of the molding material corresponds to the sum of the surface areas of the internal surfaces of the sidewalls 114A-114D, the surface area of the ejector plate 150, and the area of the opening at the top of the mold (which is equivalent to the surface area of the ejector plate 150). As a specific example, if the length of the internal surfaces of the sidewalls 114B and 114D is 21 inches, the width of the internal surfaces of the sidewalls 114A and 114C is 12 inches, and the depth D of the mold cavity is 3 inches, then the total surface area of molding material in the mold 100 is 702 in² ((2×(21 in×12 in)+(2×(12 in×3 in))+(2×(21 in.×3 in.)), and the volume of the product formed in the mold is 756 in³ (12 in×21 in×3 in). Thus, the SER of the mold 100 is 702 in²/756 in³, or 0.92 in⁻¹.

In specific embodiments of the present disclosure, molds for cold soap making processes may have a SER of greater than about 0.5 in⁻¹. More specifically, the molds may have a SER of greater than about 0.5 in⁻¹ and less than about 1.85 in⁻¹. Still more specifically, the molds may have a SER of greater than about 0.5 in⁻¹ and less than about 0.99 in⁻¹. Still more specifically, the molds may have a SER of greater than about 0.75 in⁻¹ and less than about 0.95 in⁻¹. With such configurations, molds provide for highly efficient soapmaking processes in terms of speed and product efficiency.

The slab-type molds as described herein have higher SERs than conventional soap making molds and are thereby advantageous in cold soap making processes. Slab-type molds with high SERs cause much quicker cooling of the soap making material following the saponification reaction. In contrast, molds used in conventional large-scale soap making processes have block-like shapes with relatively low SERs. Specific examples of the quicker cooling in a slab-type mold as compared to a block-type mold will be shown below.

Another advantage of using slab-type molds with higher SERs for a soapmaking processes is that the molds are more tailored to the size of individual bars of soaps as compared to conventional soap making molds. In block-type soap making molds with low SERs, individual bars of soap must be cut from the molded product along length, width, and depth directions. But with a slab-type mold having a high SER according to the present disclosure, the depth of the mold may correspond to a desired dimension of an individual bar of soap. Thus, the molded soap needs to be cut along only two directions instead of three directions as in the conventional case. And with the reduced cutting, there is much less wasted scrap product.

According to further aspects of the present disclosure, there are provided soap making processes using slab-type molds. The processes may be cold soap making processes in that no heat is added to accelerate the saponification reaction.

Conventional soap ingredients may be used in the processes, including base oil(s) and/or fat(s), lye, salt, water, and active ingredients. Specific examples of saponifiable oils that may be used include coconut oil, palm oil, and soybean oil. The lye may be sodium hydroxide, which reacts with the oils to initiate saponification and form the soap base. Sodium chloride (i.e., salt) may be included to aid in soap hardening. Examples of active components include chelating agents such as ethylenediaminetetraacetic acid (EDTA), exfoliants such as Kaolin clay, and preservatives such sodium benzoate. Fragrance compounds and colorants may also be incorporated. Those skilled in the art will recognize the wide variety of soap making materials that may be used in the processes described herein.

A process according to a particular embodiment begins with a step of filling a mixing vessel (e.g., kettle) with one or more oils or fats. In a separate mixing vessel, water, salt, and other materials such as kaolin clay are mixed until the mixture is homogeneous. The water, salt, and other material mixture is added to the mixing vessel with the oils or fats, and the combined ingredients are then mixed until the mixture is homogeneous. Next, the lye is added to the mixing vessel to begin the saponification reaction. Other ingredients, e.g., one or more fragrances, may be added after the saponification reaction reaches trace, which is when the oils and lye have emulsified and the mixture starts to thicken. The ingredients in the kettle are mixed until a desired viscosity is reached.

At this point in the method, the soap making mixture is ready for molding. Specific viscosities of the soap making mixture at this time will be discussed below. One or more of the slab-type molds as described herein may be used, with the soap making mixture being poured into the mold(s). The pour step can be conducted at a pouring station as described above. The exothermic saponification reaction may continue when the soap making mixture is in the mold(s). But once the saponification reaction stops, the soap making mixture will begin to cool in the mold(s). The cooling may take place while the mold(s) are positioned in a cooling rack as described above. As it cools, the soap making mixture solidifies into the soap product. By using a slab-type mold according to the present disclosure, the soap making mixture will solidify much quicker than in a conventional block-type mold.

When it is sufficiently solid, the soap may be removed from the mold(s). The demolding can be performed using an ejector plate lifting device as described above. Once demolded, the soap is cut into individual bars of soap. Because the soap is molded with a depth dimension that corresponds to a dimension of an individual bar of soap, a minimal amount of scrap is generated in the cutting process.

In some embodiments of the present disclosure, a soap product is made that contains two or more colors. To make such a product, two or more soap making mixtures are poured into a mold, with the soap making mixtures being different colors. In a particular example, a first soap making mixture having a first color is poured such that the mold is partially filled with the first soap making mixture. Then, a second soap making mixture having a second color is poured into the mold. Shortly after being poured into the molds and before the soap making mixtures become significantly thick, the soap making mixtures are swirled together. The resulting soap product will thereby have swirl patterns corresponding to the colors of the soap making mixtures.

In further embodiments, at least one solid component is added to the soap making mixture, with the solid component remaining after the soapmaking mixture hardens into soap. Such an additional component may provide a functionality to the soap (e.g., a fragrance) and/or make the soap more aesthetically pleasing.

According to aspects of the present disclosure, the viscosity of the soap making material during the cold soap making process is adjusted for particular use with slab-type molds having the configurations described herein. With the slab-type molds, it is advantageous for the soap making material to have a dynamic viscosity of about 47,500 cP to about 150,000 cP at the time the soap making material is poured into the molds. Soap making material may easily flow into the molds at such viscosities, while, at the same time, the soap making material is thick enough that sloshing and spillage during the pouring operation is minimized.

In embodiments involving two or more soap making materials that are to be swirled in the mold, it is advantageous for the soap making materials to have a dynamic viscosity of about 75,000 cP to about 115,000 cP at the time the soap making materials are poured into the mold. In such a viscosity range, the soap making materials will not significantly mix when they are initially poured into the mold. But the soap making materials are still in a sufficiently liquid state such that the two materials can be swirled together by hand or by an automated machine for a period following the pouring.

To determine the dynamic viscosity, techniques known in the art may be used. For example, in one technique a viscometer including a spindle is submerged in a sample, the spindle rotates in the sample, and resistance of the sample to the rotating spindle is recorded, with the dynamic viscosity thereafter being calculated. An example of a viscometer that can be used in such a process is a ViscoQC by Anton Paar.

Advantages of embodiments of the present disclosure can be expressed by the viscosity of the soap making material or materials in combination with the above-described SER property of the molds. That is, a viscosity to SER ratio (V-SER) may be defined as the viscosity of a soap making material at the time of pouring relative to the SER of the mold. For a process involving more than one soap making material, an average of the viscosity of the two soap making materials may be used. For example, if two equal amounts of soap making materials having viscosities of 80,000 cP and 90,000 cP are poured into a mold having a SER of 0.75 in⁻¹, then the V-SER in the soap making process is 85,000 cP/0.75 in⁻¹, or about 113,333 CP/in⁻¹.

In embodiments of the present disclosure, soap making processes are provided where the V-SER is greater than about 95,000 CP/in⁻¹. More specifically, processes are provided where the V-SER is about 95,000 CP/in⁻¹ to about 300,000 CP/in⁻¹. In further embodiments of the present disclosure wherein two different colored soap making materials are mixed in a mold to create a multi-colored soap product, the soap making processes are provided where the V-SER is greater than about 150,000 CP/in⁻¹. More specifically, processes are provided where the V-SER is greater than about 150,000 CP/in⁻¹ and less than about 230,000 CP/in⁻¹.

To demonstrate the advantageous effects of molds and processes according to the present disclosure, tests were conducted to compare the cooling profile of cold soap making processes in a slab-type mold with a high SER and a block-type mold with a low SER. For these tests, the slab-type mold had a SER of about 0.93 in⁻¹ and the block-type mold had a SER of about 0.39 in⁻¹. The soap making materials included conventional ingredients of a base oil, lye solution, salt, and water. Different fragrances were used in each of the test, though, as will be appreciated by those skilled in the art, the different fragrances had no effect on the results. The same procedures were used to mix the soap making materials to start the saponification reaction and the mixed soap making materials were poured into the molds using the same procedures in each case. Materials A-E were poured in the slab-type mold, and Materials F and G were poured in the block-type mold. The temperatures of the soap making materials were monitored as they cooled in the molds.

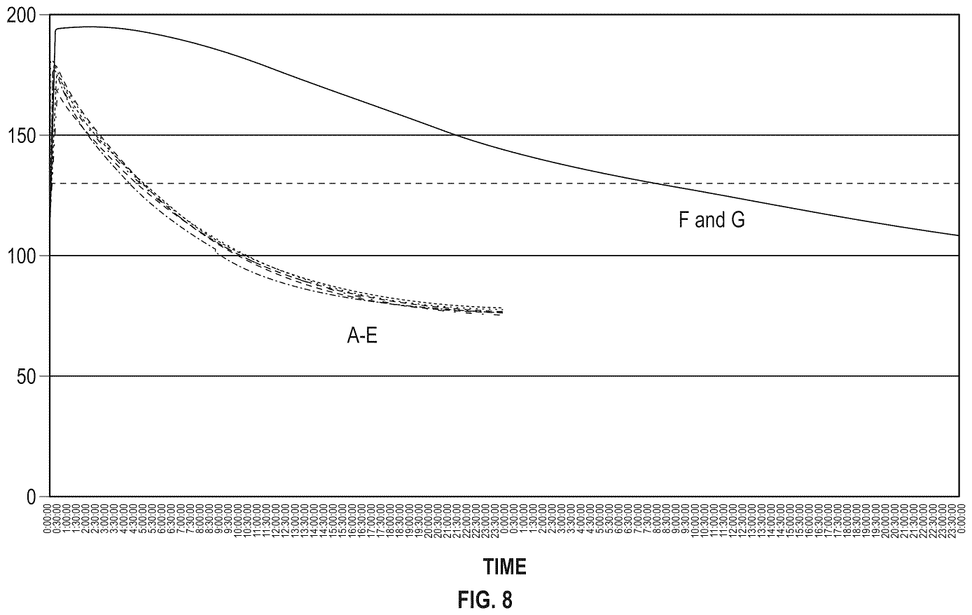

The results of the tests are shown in the graph depicted in FIG. 8, which shows the time molding time relative to the temperature (°F) of the soap making materials. As the graph shows, the Materials A-E poured in the slab-type mold with the high SER cooled much quicker than the Materials F and G cooled in the block-type mold with the low SER. To understand this significance, it can be assumed that a soap product has sufficient solidity to be removed from a mold at a temperature of about 130° F. The Materials A-E cooled in the slab-type mold all cooled to a temperature of 130° F. in 5 hours or less. On the other hand, the Materials F and G cooled in the block-type mold did not reach a temperature of 130° F. until over 32 hours. Thus, the materials cooled in the slab-type molds at a remarkably faster rate than the materials cooled in the block-type molds.

The molds and methods according to embodiments of the present disclosure provide numerous advantages over conventional soap making techniques. According to the present disclosure, soap making can be efficiently conducted at a large scale. The slab-type mold configurations according to the present disclosure minimize the amount of time needed for the soap making material to harden in a cold soap making process. The demolding of the soap from molds as described herein reduces or eliminates damage to the soap. Further, the mold configurations produce soap with dimensions such that with a minimal amount of wasted scrap is generated when the molded slab of soap is cut into individual bars.

The description of the embodiments and attached figures set forth herein serves only for a better understanding, without limiting the full scope of the present disclosure. A person skilled in the art, after reviewing the present disclosure will understand adjustments or amendments to the attached figures and above-described embodiments that still fall within the scope of the present disclosure.

1. A mold for a cold soap manufacturing process, the mold comprising:
a plurality of sidewalls, with inner surfaces of the sidewalls facing a cavity of the mold; and
a bottom connected to the sidewalls,
wherein the sidewalls and bottom are configured such that a surface efficiency ratio (SER) of the mold is greater than about 0.5 in⁻¹.

2. The mold according to claim 1, wherein the SER of the mold is greater than about 0.5 in⁻¹ and less than about 0.99 in⁻¹.

3. The mold according to claim 2, wherein the SER of the mold is greater than about 0.75 in⁻¹ and less than about 0.95 in⁻¹.

4. The mold according to claim 1, wherein the bottom of the mold includes an ejector plate supported on a bottom surface, with the ejector plate having a surface that faces the cavity of the mold, and with the ejector plate being vertically movable relative to the sidewalls and the bottom surface.

5. The mold according to claim 4, wherein at least one opening is formed in the bottom surface.

6. A mold for a cold soap molding process, the mold comprising:
a plurality of sidewalls, with inner surfaces of the sidewalls facing a cavity of the mold;
a bottom surface connected to the sidewalls;
an ejector plate provided above the bottom surface, the ejector plate having a surface that faces the cavity of the mold, and the ejector plate being movable relative to the sidewalls and bottom surface,
wherein the ejector plate and the mold are configured such that ejector plate is supported at corners of the plate and a center of plate such that the ejector plate is maintained perpendicular to the sidewalls as it moves upward.

7. The mold according to claim 6, wherein openings are formed in the bottom surface.

8. The mold according to claim 6, wherein the sidewalls and ejector plate are configured such that a surface efficiency ratio (SER) of the mold is greater than about 0.5 in⁻¹.

9. The mold according to claim 8, wherein the SER of the mold is greater than about 0.5 in⁻¹ and less than about 0.99 in⁻¹.

10. The mold according to claim 9, wherein the SER of the mold is greater than about 0.75 in⁻¹ and less than about 0.95 in⁻¹.

11. The mold according to claim 6, wherein the ejector plate is vertically movable relative to bottom surface and sidewalls.

12. A cold process of manufacturing soap, the process comprising:
forming a soap making mixture,
pouring the soap making mixture into at least one slab-type mold;
allowing the soap making mixture to harden into soap;
and removing the hardened soap from the mold,
wherein a viscosity of the soap making mixture relative to a surface efficiency ratio of the mold (V-SER) is greater than about 95,000 CP/in⁻¹.

13. The cold soap making process according to claim 12, wherein the V-SER is about 95,000 CP/in⁻¹ to about 300,000 CP/in⁻¹.

14. The cold soap making process according to claim 13, wherein the soap making mixture includes a first soap making mixture that is a first color and a second soap making mixture that is a second color, and
wherein the first soap making mixture is poured in the mold, the second soap making mixture is poured in the mold, and the first soap making mixture and the second soap making mixture are swirled together in the mold.

15. The cold soap making process according to claim 14, wherein the V-SER is greater than about 150,000 CP/in⁻¹.

16. The cold soap making process according to claim 15, wherein the V-SER is greater than about 150,000 CP/in⁻¹ and less than about 230,000 CP/in⁻¹.

17. The cold soap making process according to claim 12, further comprising adding at least one solid component to the soap making mixture, with the at least one solid component being present in the hardened soap.

18. The cold soap making process according to claim 12, wherein the soap making mixture is poured into more than one slab-type mold.

19. The cold soap making process according to claim 18, wherein the soap making mixture is poured into six or more stab-type molds.

20. The cold soap making process according to claim 12, wherein no heat is added to accelerate a saponification reaction in the soap making mixture.
